(19) United States
(12) Patent Application Publication
(10) Pub. No.: US 2002/0040708 A1
(43) Pub. Date: Apr. 11, 2002

(54) Method of operating an internal combustion engine

(76) Inventors: Franz Chmela, Graz (AT); Janos Csato, Graz (AT); Michael Glensvig, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/967,917

(22) Filed: Oct. 2, 2001

(30) Foreign Application Priority Data
Oct. 3, 2000 (AT) GM 727/2000

(51) Int. Cl. F02M 25/07

(52) U.S. Cl. 123/568.14; 123/568.12; 123/543

(57) ABSTRACT

A method of operating an internal combustion engine that is provided with at least one operation mode in which combustion substantially occurs by spontaneous ignition of a spontaneous ignitable, homogeneous fuel-air mixture, the share of inert gas in the combustion chamber being adjusted. In order to be able of controlling the start of the combustion and the maximum rate of combustion irrespective of one another, there is provided that nominal values for the actual intake-air temperature and for the actual share of inert gas are determined in function of actual motor parameters, that actual values are detected for the actual intake-air temperature and for the actual share of inert gas and that the curve of temperature of the charge and the share of inert gas are adjusted by controlling both the amount of residual exhaust gas contained in the combustion chamber and the amount of externally recycled exhaust gas on account of the deviation of the actual values from the nominal values.

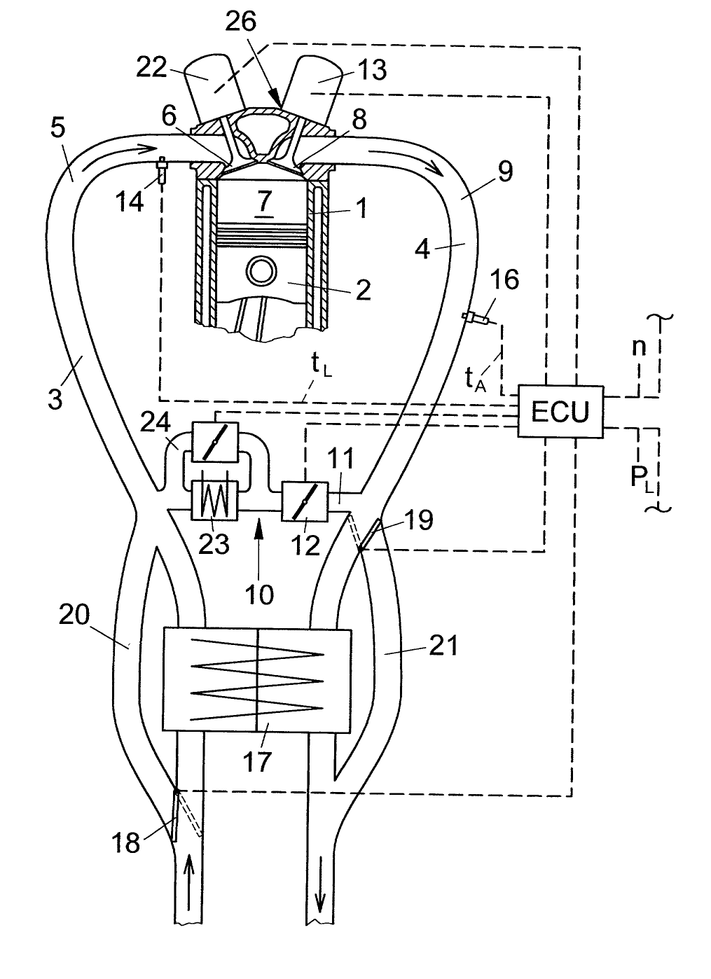

### BACKGROUND OF THE INVENTION

The invention relates to a method of operating an internal combustion engine that is provided with at least one operation mode in which combustion substantially occurs by spontaneous ignition of a spontaneous ignitable, homogeneous fuel-air mixture, the share of inert gas in the combustion chamber being adjusted. The invention is also directed to an internal combustion engine that is provided with at least one operation mode in which combustion substantially occurs by spontaneous ignition of a spontaneous ignitable, homogeneous fuel-air mixture with a unit for controlling the amount of inert gas contained in the combustion chamber.

The most important determining pieces for the combustion process in an internal combustion engine are the phase position of the combustion process or of the combustion start respectively, the maximum speed at which the pressure in the cylinder increases, as well as the peak pressure.

In an internal combustion engine, in which combustion substantially occurs by spontaneous ignition of a spontaneous ignitable, homogeneous fuel-air mixture, these determining pieces are established by controlling the composition and the temperature curve of the charge. These two quantities are in turn determined by a great number of influence quantities such as the number of revolutions, the amount of fuel, the intake temperature, the pressure of the charge, the effective compression ratio, the amount of inert gas contained in the cylinder charge and the temperature of the components for example.

It appears that the temperature of the charge plays a particularly important part in controlling the speed at which the chemical processes occur during the ignition delay and the very combustion. A very efficient means for increasing the temperature of the charge is to increase the amount of residual gas, that is to say, to increase the amount of non-scavenged exhaust of the previous combustion cycle in the cylinder charge for the next cycle.

### DESCRIPTION OF PRIOR ART

AT 003 135 U1 describes an internal combustion engine that, in at least one operational mode, burns a homogeneous fuel-air mixture by the spontaneous ignition of a fuel that may be either spark or spontaneously ignited, more specifically gasoline. As a result thereof, the operation may achieve particularly favorable emission values in the underload range. In order to be able to control the quantity of the residual gas in the sense of an internal exhaust recycling for the purpose of raising the temperature of the charge in the underload range, there is provided that the closing time of at least one exhaust valve may be changed in function of operating parameters of the motor by way of a variable valve timing gear. The internal recycling of the exhaust gases or the control of the amount of residual exhaust gas contained in the combustion chamber respectively, also causes the amount of inert gas to increase. In order to be capable of controlling the start of the combustion and the maximum rate of combustion irrespective of each other, it would be necessary to control the amount of inert gas irrespective of the temperature need, though.

### SUMMARY OF THE INVENTION

It is the object of the invention to avoid these disadvantages and to improve the control of the combustion process with internal combustion engines burning homogeneous, spontaneously ignitable fuel-air mixtures. More specifically, the start of the combustion and the maximum rate of combustion are intended to be controllable irrespective of one another.

This object is achieved according to the invention in that nominal values for the actual intake-air temperature and for the actual share of inert gas are determined in function of actual motor parameters, that actual values are detected for the actual intake-air temperature and for the actual share of inert gas and that the curve of temperature of the charge and the share of inert gas are adjusted by controlling both the amount of residual exhaust gas contained in the combustion chamber and the amount of externally recycled exhaust gas on account of the deviation of the actual values from the nominal values. By combining the control of the residual exhaust gas and the external recycling of exhaust and by suitably adapting the amounts of residual gas and of recycled exhaust, the amount of inert gas may be controlled irrespective of the temperature need. Accordingly, the curve of temperature of the charge and the share of inert gas can be arranged irrespective of one another within a wide range of variegation by appropriate adjustment of the amount of residual gas that increases the temperature of the charge and of the externally recycled exhaust that reduces the temperature of the burnable gas. This is made possible by the fact that the unit for controlling the amount of inert gas is provided with an external unit for recycling exhaust and with a unit for controlling the residual gas and that the temperature curve of the charge-air and the share of inert gas may be adjusted by controlling the share of residual gas and the share of the externally recycled exhaust.

In accordance with an embodiment of the invention, the control of the amount of residual gas may be realized in changing the closing time of at least one exhaust valve for the purpose of controlling the amount of residual gas. Moreover, the amount of residual gas—together with a slight reduction in gas exchange—may be controlled by the late opening of the exhaust valve during the intake phase. To achieve this there is provided that the control means of the residual gas be provided with a variable control means of the valve for changing the exhaust valve timing. Additional control of the temperature curve of the charge may be achieved by the fact that the intake timing and, as a result thereof, the effective compression rate may be variably modified. The variable valve control unit for changing the exhaust or the intake valve timing and for the late opening of the exhaust valve may be designed either as a hydraulic accessory control unit to a valve timing gear driven by a camshaft or as a fully flexible, variable valve timing gear on a hydraulic or electromechanical basis.

The control of the amount of residual gas and of the amount of externally recycled exhaust occurs by way of a control unit that prescribes the nominal values for the temperature of the charge and for the share of inert gas in function of operating parameters of the motor, such as number of revolutions, amount of fuel, intake temperature, pressure of the charge, loading condition, and so on. The nominal values may be recorded in a motor diagram. The required amount of residual gas and the amount of externally recycled exhaust are determined by means of the nominal values and both the valve control unit and an exhaust recycling valve of the exhaust recycling unit are actuated accordingly.

Additionally, the control of the temperature curve of the charge may also occur through an exhaust heat exchanger controlled by flaps that is arranged in the intake branch.

The control of the temperature of the charge and of the amount of residual gas by way of variable valve timing also meets the requirement that these two quantities must be changeable at any speed, that is to say from one cycle to the other, in order to permit a transient operation of the motor.

The invention is explained in more detail with the help of the drawing.

### DETAILED DESCRIPTION OF THE PREFERRED EMBODIMENTS

The FIGURE is a schematic illustration of an internal combustion engine with an arbitrary number of cylinders 1 for reciprocating pistons 2. The internal combustion engine is provided with an inlet system 3 and with an outlet system 4. An intake manifold 5 being part of the inlet system 3 is illustrated, said manifold discharging through at least one intake valve 6 into the combustion chamber 7 of a cylinder 1. At least one exhaust line 9 of the outlet system 4 that is controlled by an exhaust valve 8 exits the combustion chamber 7. Between the outlet system 4 and the inlet system 3 there is provided an external exhaust recycling system 10 that brings the exhaust line 9 in flow connection with the intake line 5 by way of an exhaust recycling line 11. Both an exhaust recycling valve 12 and an exhaust cooler 23 are arranged in the exhaust recycling line 11, wherein the exhaust cooler 23 may be designed in such a manner that it may be by-passed by way of a line 24. An on/off valve located in the line 24 is indicated at 25.

In order to be capable of controlling, to a large extent independently of the amount of inert gas, the curve of temperature of the charge t_{LA} in the combustion chamber 7 and, as a result thereof, the combustion process of the homogeneous, spontaneously igniting fuel-air mixture, both the share of residual gas in the combustion chamber 7 and the amount of recycled exhaust gas are controlled. Thanks to the independent control of the amount of inert gas and of the temperature need, the start of the combustion and the maximum rate of combustion can be controlled irrespective of one another.

The control of the amount of residual gas contained in the combustion chamber 7 is conducted by means of a control unit for the residual gas 26 by changing the exhaust timing or the exhaust valve(s) 8 by way of a variable valve control unit 13. Alternatively, the amount of residual gas may also be controlled by a late opening of the exhaust valve 8 during the intake phase. This occurs without any increase in gas exchange. The variable valve control unit 13 may be a hydraulic accessory control unit of a valve timing driven by a camshaft or a fully flexible variable valve timing gear on a hydraulic or electromechanical basis.

The control of the quantity of recycled exhaust occurs through the exhaust recycling valve 12. The valve control unit 13 and the exhaust recycling valve 12 are actuated through the electronic control unit ECU in which nominal values for the intake temperature t_{LS} and the share of inert gas are recorded for each point of motor operation. The actual values for the intake-air temperature t_{L} and for the share of inert gas are detected either continuously or in appropriate periods of time. The exhaust recycling valve 12 and the valve control unit 13 are actuated in an appropriate fashion in accordance with the deviation of the actual values from the nominal values for the share of inert gas and for the intake-air temperature t_{LS} in the combustion chamber 7. Various motor operating parameters such as actual intake-air temperature t_{L}, exhaust temperature t_{A}, number of revolutions n, pressure of the charge p_{L}, and so on serve as input quantities for the electronic control unit ECU, the temperatures t_{L} and t_{A} being detected by sensors 14 and 16.

For controlling the temperature curve of the intake t_{LA}, there may be provided in the inlet system 3 an exhaust heat exchanger 17 as an additional means, wherein said exhaust heat exchanger may be actuated or deactivated through control valves that are realized as flaps 18, 19 for example. The exhaust heat exchanger 17 may be by-passed both on the side of the inlet system 3 and on the side of the outlet system 4 by way of by-pass lines 20, 21.

Furthermore, the temperature curve of the charge t_{LA} may also be influenced by changing the intake valve timing of the intake valves 6 by way of a variable valve control unit 22. Said valve control unit may be realized as a hydraulic accessory control unit to a valve control with camshaft or as a fully flexible valve control on a hydraulic or electromechanical basis.

What is claimed is:

1. A method of operating an internal combustion engine that is provided with at least one operation mode in which combustion substantially occurs by spontaneous ignition of a spontaneous ignitable, homogeneous fuel-air mixture, the share of inert gas in a combustion chamber being adjusted, wherein nominal values for an actual intake-air temperature and for an actual share of inert gas are determined in function of actual motor parameters, that actual values are detected for the actual intake-air temperature and for the actual share of inert gas and that the curve of temperature of the charge and the share of inert gas are adjusted by controlling both an amount of residual exhaust gas contained in the combustion chamber and an amount of externally recycled exhaust gas on account of a deviation of the actual values from the nominal values.

2. The method according to claim 1, wherein a closing time of at least one exhaust valve is changed for the purpose of controlling the amount of residual gas.

3. The method according to claim 1, wherein the exhaust valve is opened once more during an intake phase for the purpose of controlling the amount of residual gas.

4. The method according to claim 1, wherein a temperature curve of the charge is additionally adjusted by way of a heat exchanger.

5. The method according to claim 4, wherein the heat exchanger is controlled by at least one flap.

6. The method according to claim 4, wherein the temperature curve of the change is additionally adjusted by way of an exhaust heat exchanger that is arranged in an inlet system.

7. The method according to claim 1, wherein the temperature of the charge is additionally adjusted by changing an intake valve timing.

8. An internal combustion engine that is provided with at least one operation mode in which combustion substantially occurs by spontaneous ignition of a spontaneous ignitable, homogeneous fuel-air mixture with a unit for controlling the amount of inert gas contained in a combustion chamber wherein the unit for controlling the amount of inert gas is provided with an external unit for recycling exhaust and with a unit for controlling a residual gas and that a temperature curve of the charge and a share of inert gas may be adjusted by controlling the share of residual gas and the share of an externally recycled exhaust.

9. The internal combustion engine according to claim 8, wherein a control unit of the residual gas is provided with a variable valve control unit for changing an exhaust valve timing and/or an intake valve timing.

10. The internal combustion engine according to claim 8, wherein the intake timing may be variably modified.

11. The internal combustion engine according to claim 8, wherein there is provided in an inlet system of the internal combustion engine a heat exchanger.

12. The internal combustion engine according to claim 11, wherein the heat exchanger is an exhaust heat exchanger.

13. The internal combustion engine according to claim 11, wherein the heat exchanger is controlled by at least one flap.
